(19) United States
(12) Patent Application Publication
(10) Pub. No.: US 2005/0098087 A1
(43) Pub. Date: May 12, 2005

(54) Stake driving device and method

(76) Inventor: Willard D. Carroll JR., Abilene, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 10/705,083

(22) Filed: Nov. 10, 2003

(51) Int. Cl. G01D 21/00

(52) U.S. Cl. 116/209

(57) ABSTRACT

A stake can be driven into a surrounding terrain using a point drive system. The stake body is formed of a durable material such as plastic with a pointed bottom end and a top end which can carry a bundle of colored filaments. The stake body has a hollow interior bore extending from a top end opening downwardly to a bottom end opening. The hollow interior bore of the stake receives a pointed shaft driver which allows the stake to be driven into even difficult terrains in point drive fashion.

### BACKGROUND ART

1. Field of the Invention

The invention relates to stakes adapted to be driven into a surrounding terrain, to a method for driving stakes, and more specifically, to a marker stake such as is used in construction work such as road building and its method of installation.

2. Description of Related Art

The advantages of the stakes of the invention can perhaps be best understood with reference to one prior art field of use, namely as a grading or marker stake. Grading stakes are one type of marker device commonly used in a variety of building and construction industries. Grading stakes are used to indicate the level to which the surrounding terrain must be graded. The stakes are customarily driven to a specified level relative to the existing surface and frequently include a brightly painted top to indicate the existence of the stake top and the level to which the surface ground is to be cut or filled. Other typical uses in the construction industries include topographic surveys of the site to be used in the preparation of plans for a structure and locating in the soil a system of stakes or other markers both in plan and in elevation from which the construction crew can take measurements of earthwork and other measurements for the proper construction of structures. Additionally, temporary stakes or other markers are usually set at the comers of proposed structures, as an approximate guide for beginning the excavation.

Although the top of grading stakes may be initially visible, for example, when the stake top is above the existing ground or is set in a small hand-dug hole, the stakes are frequently covered during the passes of the grader. To improve the visibility of the grading stake, a flag comprising a bundle of brightly colored, polymer filaments is attached to the top end of the stake. In this manner, the colored flag or whiskers will first appear before the top of the stake is reached.

U.S. Pat. No. 3,903,835, entitled GRADE INDICATOR STAKE FLAG HOLDER, issued 9 Sep. 1975, and assigned to the assignee of the present invention shows a marker stake in which the flag or filament bundle is folded at the center and retained by a metal crimp band. The band includes a staple device for attaching the banded filaments to the top of a wooden stake by driving the staple device into the top of the stake. The stake itself would be installed in the surrounding terrain with a hand tool, such as a hammer.

U.S. Pat. No. 5,501,170, entitled “Grading Stake With Indicator Flag”, issued Mar. 26, 1996, to Walsh, purports to avoid the various problems of utilizing an indicator flag that is attached to a wooden grading stake by an attachment means that penetrates the stake. In the Walsh reference, a bundle of colored filaments are fastened at one end to the top end of the stake member by a tape wrap which is wound around the end of the bundle of colored filaments and the top end of the stake member. The stake is installed in the surrounding terrain with a hand tool.

U.S. Pat. No. 5,174,237, entitled “Grade Marker”, issued Dec. 29, 1992, to Beard shows a grade marker in which the location of the stake is found by the feather that is held by a clip which is driven into the side of the stake. Again, the stake is installed using a hand tool.

Despite improvements made in marker stakes of the above type, certain problems continue to exist. The setting of prior art wooden stakes has been time consuming and tiresome in that workers were required to bend over to insert the stakes into the ground. Also, the methods used to drive the stakes into a surrounding terrain were often less than satisfactory. Pounding the top of a wooden stake with a hammer or like tool often caused the stake to split. Also, it was difficult or impossible to drive certain of the prior art stakes into difficult terrains such as rocky ground.

A need exists for a more ergonomic system for installing stakes which is less labor intensive and which is simple in design and operation.

A need exists for an improved marker stake which more conveniently attaches the filaments of a colored whisker flag to the stake.

A need also exists for a device for driving a stake which allows the stake to penetrate difficult terrain more easily.

A need also exists for an improved stake for use with such a driver device which is more durable than existing designs.

### BRIEF SUMMARY OF THE INVENTION

The improved stake of the invention includes a stake body which is formed of a durable, light weight material such as a synthetic, polymeric material. The stake body has a bottom end which terminates in a bottom end opening, an intermediate sidewall portion and a top end which terminates in a top end opening. The stake body has a hollow interior bore which communicates the top and bottom end openings, the interior bore being sized to receive a special driving tool for driving the marker stake into the ground. Preferably, the top end opening is also selectively sized to receive an end cap of a filament bundle. The end cap can be frictionally retained in the top end opening whereby a filament bundle of stiff, resilient strands form an indicator flag when the end cap is seated within the top end opening of the stake body.

In one embodiment of the marker stake version of the invention, the stake body has a cylindrical sidewall portion which is joined to the top end by a frusto-conical wall region. The frusto-conical wall region terminates in a top, planar exposed end surface. The top, planar exposed end surface has an outer periphery, the outer periphery being of a larger relative diameter than the diameter of the cylindrical sidewall portion of the stake body. In one embodiment of the invention, the end cap of the filament bundle is seated within the top end opening so that it is generally centrally located on the top, planar exposed end surface of the stake body.

The stake of the invention can be driven into the surrounding terrain by using a simple tool comprised of a solid bar having a length and having a drive shoulder formed at one location along its length. The solid bar also has a drive end and an oppositely arranged pointed end. The solid bar is engaged within the hollow interior bore of the stake body with the pointed end thereof extending slightly from the bottom end opening. Force exerted on the upper, drive end of the solid bar serves to exert a downward driving force on the drive shoulder and on the stake body to drive the stake body into the surrounding terrain.

The above as well as additional objects, features, and advantages of the invention will become apparent in the following detailed description.

### BRIEF DESCRIPTION OF THE DRAWINGS

FIG. 1 is a side, cross sectional view of a stake useful in practicing the method of the invention, and also illustrating a method of seating a filament bundle within a top end opening of the stake.

FIG. 2 is a profile view of the stake of FIG. 1 in place in the surrounding terrain and with the filament bundle seated in the top end opening of the stake.

FIGS. 3-5 illustrate the steps involved in installing a filament bundle in the end cap used with the stake of the invention.

FIG. 6 is side, profile view of the stake of the invention showing the pointed shaft driver which is used to drive the stake into the surrounding terrain.

FIG. 7 is a view similar to FIG. 6, but showing the stake in cross section with the shaft of the driver received within the hollow interior bore of the stake.

FIG. 8 is a perspective view of a prior art wooden stake.

### DETAILED DESCRIPTION OF THE PREFERRED EMBODIMENT

In order to explain the advantages of the present invention, reference will first be made to the prior art wooden stakes commonly used in the industry. While the invention will be described with respect to a preferred embodiment as a marker stake, those skilled in the art will understand that the stakes of the invention can be used in a variety of applications such as tent stakes, as trail or backpack marking devices, as markers for sports fields, as roadside markers, etc. FIG. 8 of the drawings shows a prior art grading stake with indicator flag, designated generally as 10. The grading stake comprises a wooden stake member, shown here as a dowel 12 having a conically turned, pointed end 14 to enable the stake 10 to be driven into the ground. A top end 16 of the stake includes a flat top 18 that may be brightly colored to indicate the grade level that the ground is to be cut or filled by conventional grading equipment. Connected to the top end 16 of the stake 10 is a flag 20 that is comprised of a bundle of polymer, monofilaments 21 that are brightly colored to signal the location of the stake 10.

The filament bundle 21 is constructed with a plurality of individual filaments 22 having a looped end 24 that is crimped and held by a ⅜″ tape band 26 to form the flag 20. The looped end of the filament bundle 21 is attached to the top end 16 of the stake member 12 by a 1″ tape wrap 28 formed of a high strength, filament-impregnated, packing tape. The tape wrap 28 is wound a multiple number of turns around the top end 16 of the stake member 12 and the crimped end 24 of the filament bundle 21.

There were various disadvantages associated with the prior art stake. The filament bundle used on the marker stake shown in FIG. 8 could be fairly easily dislodged since it was merely taped into position. In the case of wooden stakes having nailed on filament bundle, extra care was required to avoid splitting the wood during installation. Also, the solid wooden stake did not provide access for any type of installation device which would obviate the need for a user to bend from the waist when installing the stake. The solid wooden stakes did not include a “point drive” system to facilitate driving the stake into hard terrain such as rocky ground.

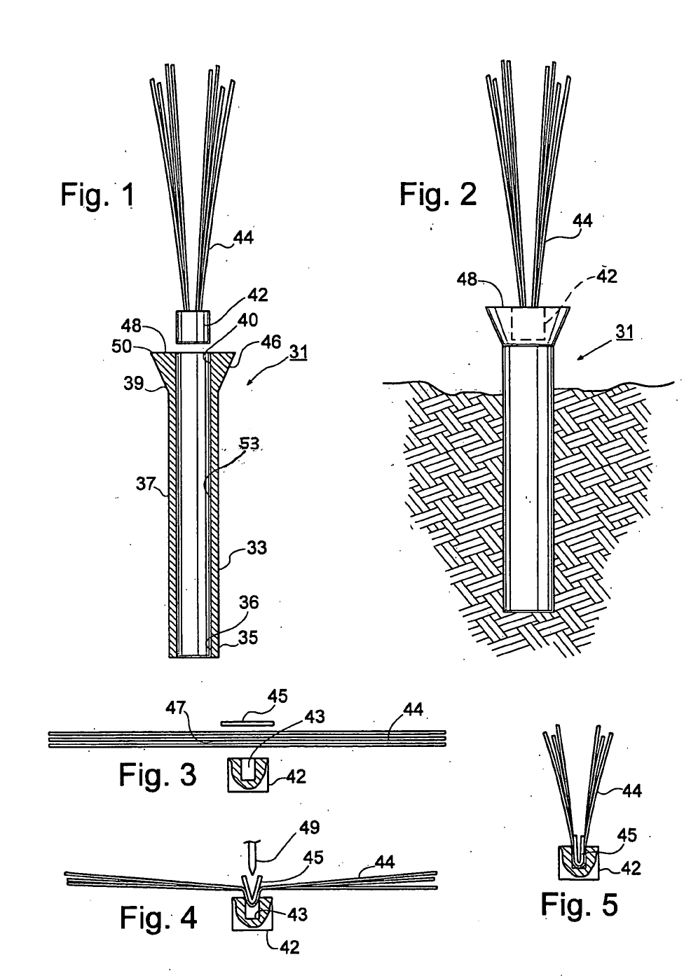

FIG. 1 shows a marker stake of the invention, designated generally as 31. The stake body can be formed of any of a number of conveniently available materials. The material may be any suitable material which is capable of being formed into a device of the desired structure having sufficient mechanical strength. The stake body 33 is preferably formed of a synthetic, polymeric material such as polypropylene, high density polyethylene, ABS or other suitable plastic which can be injection molded. However, other durable, light weight materials might also be utilized in some applications such as aluminum or other light weight metals or metal alloys. In fact, a biodegradable material may be used in some applications.

For example, biodegradable containers for seedling plants are known in the prior art for use by foresters in air drop planting techniques and these same type materials may be utilized in the practice of the present invention. U.S. Pat. No. 3,273,284, to Anagnostou, shows such a planting device which is made of a material which disintegrates upon exposure to water and which is formed from fertilizers and pulp. Similarly, U.S. Pat. No. 4,333,265, to Arnold, shows a cone shaped container formed of powder molded urea-formaldehyde resin including nutrient enriched ingredients. The particular biodegradable material utilized in Arnold is an organic nitrogen fertilizer which is acted upon by soil bacteria to provide timed release of the nitrogen content of the fertilizer. This fertilizer, known as ureaform, is commercially available under the registered trademark NITROFORM by Boots Hercules Agrochemicals Company of Wilmington, Del. The ureaform constitutes a soil bacteria degradable polymeric material which makes nitrogen available in a controlled release fashion. This and other biodegradable materials can be molded in the form of Applicant's stake and used for various forestry and agricultural purposes.

The outer shape or configuration of the stake body is not critical and various shapes can be utilized, if desired. For example, even though the discussion which follows will describe the stake body in terms of a generally cylindrical outer configuration, other shapes could be utilized including square, triangular, or various other polygonal shapes. In the embodiment of the invention shown in FIGS. 1 and 2, the stake body 33 has a bottom end 35 which terminates in a bottom end opening 36, an intermediate sidewall portion 37, and a top end 39 which terminates in a top end opening 40. The stake body has a hollow interior bore 42 which communicates the top and bottom end openings 36, 40, respectively. As will be explained in greater detail, the interior bore 40 is sized to receive a special driving tool for driving the marker stake into the ground.

As shown in FIGS. 1 and 2, the top end opening 40 is also selectively sized to receive an end cap 42 of a filament bundle 44 once the stake has been driven into place within a surrounding terrain. The end cap is generally cylindrical in shape so that it can be easily pressed fit within the top end opening 40 and can be formed of any convenient material, preferably a synthetic polymer such as that used for the stake. The end cap 42 is frictionally retained in the top end opening whereby a filament bundle of stiff, resilient strands 44 form an indicator flag when the end cap is seated within the top end opening 40 of the stake body 33. The end cap 42 can also be glued or otherwise retained within the top end opening 40. While the end cap 42 illustrated in the drawings is a preferred embodiment, the invention is not intended to be thus limited. As will be apparent from the following discussion, the improved stake and drive system of the invention can be utilized with (1) stakes with no flag strands, (2) stakes with pre-attached strands, (3) stakes with a plug style end cap such as cap 42; or (4) stakes with a cap which fits over the stake end.

FIGS. 3-5 illustrate the method used for attaching the filament bundle 44 to the end cap 42. A recess 43 is provided in the top surface of the end cap 42. An attachment means is provided for attaching the filament bundle within the recess 43. In the preferred form, the attachment means can comprise a metal strip or wire 45 which is initially flat or unbent. The metal strip 45 initially overlays a mid-region 47 of the filament bundle 44 when the bundle is received across the recess 43 in the top surface of the end cap. As shown in FIG. 4, a simple hand tool, such as the pointed driver 49 can then be used to bend the metal strip 45 by forcing it into the recess 43 in the top surface of the end cap. This action serves to retain the filament bundle 44 within the recess 43 since the bent strip 45 engages the sidewalls of the recess 43.

In the particular embodiment of the marker stake illustrated in FIGS. 1 and 2, the stake body cylindrical sidewall portion 37 is joined to the top end by a frusto-conical wall region 46 which also defines a top, planar exposed end surface 48. The end surface 48 has an outer periphery 50, the outer periphery being of a larger relative diameter than the diameter of the cylindrical sidewall portion 37 of the stake body 33. The end cap of the filament bundle 44 is seated within the top end opening 40 so that it is centrally located on the top, planar exposed end surface 48 of the stake body 33. While the marker stake illustrated in FIGS. 1 and 2 is shown provided with a pair of filament bundles, it will be understood that one or more additional bundles or a single bundle could be provided as well of a different relative height or color or texture.

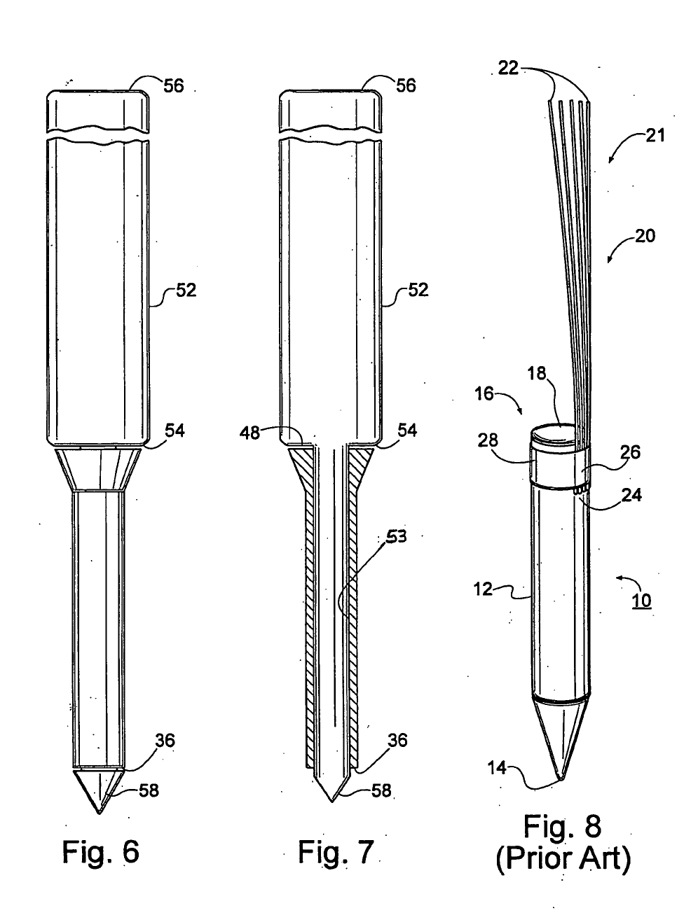

As shown in FIGS. 1 and 7, the stake interior bore 53 is sized to receive a driving tool or implement for driving the marker stake into a surrounding terrain. The stake of the invention can be driven into the surrounding terrain by using a simple tool or driver 52 comprised of a suitable hard material and having a drive shoulder 54 formed at one location along its length. The bar 52 also has a drive end 56 and an oppositely arranged pointed end 58. The driver 52 can conveniently be formed as a solid steel bar with the pointed end 58 being further heat treated or hardened, if desired. As will be appreciated, the bar 52 comprises a “pointed shaft driver” for the stake. As shown in FIGS. 6 and 7, the drive bar 52 is engaged within the hollow interior bore 42 of the stake body 33 with the pointed end 58 thereof extending slightly from the bottom end opening 36. Force exerted on the upper, drive end 56 of the drive bar 33 serves to exert a downward driving force on the drive shoulder 54 and on the upper planar surface 48 of the stake body to drive the stake body into the surrounding terrain.

The drive bar 52 together with the hollow bore 42 form a “point drive” system for the stake of the invention. The drive bar 52 is first inserted within the hollow bore 42 as shown in FIGS. 6 and 7. If the drive bar 52 is closely received within the bore 42, then the stake can be lowered into position without the necessity of the user bending at the waist. Perhaps more importantly, the durable material of the drive bar, including the pointed end 58, provide a concentrated driving force which allows the stake to be driven into difficult terrains which would otherwise tend to bend or break other driving systems.

An invention has been provided with several advantages. The marker stakes of the invention are formed of durable, lightweight materials, such as synthetic, polymeric materials which are extremely sturdy and resistant to environmental attack. Alternatively, the stake body may be formed of a biodegradable material. The attachment means of the invention securely engages the filament bundle to the top surface of the stake so that the bundle is practically impossible to accidentally dislodge. The hollow interior of the stake body receives a pointed shaft driver which allows a user to install a stake without repeatedly bending from the waist. The point drive system allows the stake to be installed in terrains which would have been difficult or impossible to access with the prior art devices. The stakes of the invention can be driven into limestone or caliche soils that, in the past, would have required railroad spikes, or the like. The polymeric components of the stake of the invention allow the stake to be provided in a variety of colors and textures including the use of multiple filament bundles of different heights and colors.

While the invention is shown in only one of its forms, it is not just limited but is susceptible to various changes and modifications without departing from the spirit thereof

1. In combination, a marker stake and a driver which, together with the stake, form an integral point drive system, comprising:
a stake body formed in one piece of a synthetic polymeric material, the stake body having a length, a bottom end which terminates in a bottom end opening, an intermediate sidewall portion and a top end which terminates in a top end opening;
a driver having a stepped cylindrical body including a drive shoulder located along a length thereof between a drive end and an oppositely arranged pointed end of the body;
wherein the stake body has a cylindrical sidewall portion which is joined to the top end by a frusto-conical wall region which also defines a top, planar exposed end surface, and wherein the planar exposed end surface has an outer periphery, the outer periphery being of a larger relative diameter than the diameter of the cylindrical sidewall portion of the stake body, the top, planar exposed surface being selectively sized to receive the drive shoulder of the pointed shaft driver for driving the stake into the surrounding terrain; and
wherein the stake body has a hollow interior bore which communicates the top and bottom end openings, the interior bore being sized to closely receive a portion of the cylindrical body of the driver with the driver pointed end extending at least sightly from the bottom end of the stake body, whereby the stake can be retained frictionally on the driver to allow a user to drive a stake into the surrounding terrain without the necessity of bending.

2. (canceled)

3. The stake of claim 1, wherein the stake body also has a pre-attached filament bundle located on an external surface thereof.

4. The stake of claim 1, wherein a filament bundle is provided having an end portion which is inserted within the hollow interior bore of the stake body in order to retain the filament bundle on the stake body.

5. The stake of claim 1, wherein a filament bundle is provided with an end cap which is received over an exposed end of the stake body in order to retain the filament bundle on the stake body.

6. The stake of claim 1, wherein no filament bundle is present on the stake body, the hollow interior bore remaining unobstructed.

7. (canceled)

8. (canceled)

9. In combination, a marker stake, an end cap and a driver which, together with the stake, form having an integral point drive system, comprising:
a stake body formed in one piece of a synthetic polymeric material, the stake body having a bottom end which terminates in a bottom end opening, an intermediate sidewall portion and a top end which terminates in a top end opening;
a driver having a stepped cylindrical body including a drive shoulder located alone a length thereof between a drive end and an oppositely arranged pointed end of the body;
wherein the stake body has a cylindrical sidewall portion which is joined to the top end by a frusto-conical wall region which also defines a top, planar exposed end surface, and wherein the planar exposed end surface has an outer periphery, the outer periphery being of a larger relative diameter than the diameter of the cylindrical sidewall portion of the stake body, the top, planar exposed surface being selectively sized to receive the drive shoulder of the pointed shaft driver for driving the stake into the surrounding terrain;
wherein the stake body has a hollow interior bore which communicates the top and bottom end openings, the interior bore being sized to closely receive a portion of the cylindrical body of the driver with the driver pointed end extending at least sightly from the bottom end of the stake body, whereby the stake can be retained frictionally on the driver to allow a user to drive a stake into the surrounding terrain without the necessity of bending; and
wherein the top end opening of the stake body is also selectively sized to receive an end cap of a filament bundle having associated stiff, resilient strands, whereby the end cap is frictionally retained in the top end opening after the driver has been used to drive the stake into the surrounding terrain, whereby the filament bundle of stiff, resilient strands forms an indicator flag when the end cap is seated within the top end opening of the stake body.

10. (canceled)

11. (canceled)

12. The stake of claim 9, wherein the stake body is formed of a biodegradable material.

13. (canceled)

14. A method of driving a marker stake into a surrounding earthen terrain, the method comprising the steps of:
providing a stake body formed in one piece of a synthetic polymeric material, the stake body having a bottom end which terminates in a bottom end opening, an intermediate sidewall portion and a top end which terminates in a top end opening, the top end also forming a top, planar exposed end surface for the stake body;
wherein the stake body has a hollow interior bore which communicates the top and bottom end openings, the interior bore being sized to receive a driving tool for driving the marker stake into a surrounding terrain;
inserting a pointed shaft driver into the hollow interior bore of the stake body, the driver having a length and having a drive shoulder formed at one location along its length, the driver having a drive end and an oppositely arranged pointed end, the driver being frictionally engaged within the hollow interior bore of the stake body with the pointed end thereof extending slightly from the bottom end opening of the stake;
exerting a drive force on the upper, drive end of the pointed shaft driver with a hand tool, whereby a downward driving force is exerted on the drive shoulder and on the top, planar exposed end surface of the stake body the pointed end of the driver initially contacting the earthen terrain to facilitate driving the stake body into the surrounding terrain.

15. The method of claim 14, further comprising the steps of:
withdrawing the pointed shaft driver from the hollow interior bore of the stake body;
providing a filament bundle with an end cap and installing the end cap within the top end opening of the stake body, whereby the end cap is frictionally retained in the top end opening and the filament bundle forms an indicator flag when the end cap is seated within the top end opening of the stake body, the end cap being removable by pulling upwardly on the filament bundle.

16. The method of claim 15, wherein an attachment means is provided for attaching the filament bundle to a recess provided in an exposed top surface of the end cap, the attachment means comprising a metal strip which overlays a mid region of the filament bundle when the bundle is received across the recess in the top surface, whereby bending the metal strip by forcing it into the recess on top of the filament strands serves to retain the filament bundle within the recess provided in the top surface of the end cap.
